(19) United States
(12) Patent Application Publication
(10) Pub. No.: US 2025/0037283 A1
(43) Pub. Date: Jan. 30, 2025

(54) Seamless Transitions for Video Person Segmentation

(71) Applicant: Apple Inc., Cupertino, CA (US)

(72) Inventor: Gustaf G. Pettersson, Cupertino, CA (US)

(21) Appl. No.: 18/785,835

(22) Filed: Jul. 26, 2024

Related U.S. Application Data
(60) Provisional application No. 63/515,919, filed on Jul. 27, 2023.

(51) Int. Cl. G06T 7/10; G06T 7/50; G06T 7/70; G06V 10/25

(52) U.S. Cl. CPC G06T 7/10; G06T 7/50; G06T 7/70; G06V 10/25; G06T 2207/20084; G06V 2201/07

(57) ABSTRACT

Devices, methods, and non-transitory computer readable storage mediums for the seamless transition of subject into an image or scene are disclosed. The methods include obtaining a first image of a scene, the first image including at least a first subject. A first alpha mask is generated for the first image based on an image segmentation operation. A depth map is generated for the first image, and a foreground depth is determined for the scene. A second alpha mask is generated by modifying the first alpha mask based, at least in part, on comparisons between values in corresponding portions of the depth map and the determined foreground depth. The second alpha mask modifies an opacity of at least some portions of the first image corresponding to the location of the first subject.

### CROSS REFERENCE TO RELATED APPLICATIONS

This application claims priority under 35 U.S.C § 119 to U.S. Provisional Application No. 63/515,919 filed on Jul. 27, 2023. The contents of which are hereby incorporated by reference in its entirety.

### TECHNICAL FIELD

This disclosure relates generally to the field of digital image processing. More particularly, but not by way of limitation, it relates to techniques for seamless transitions in the opacity of persons (or other objects of interest) in captured image data based on their estimated depth in the scene, e.g., leveraging video image segmentation techniques.

### BACKGROUND

Many modern electronic products have the capability to capture and process image data. For example, laptop computers, tablet computers, smartphones and personal media devices may include cameras to capture image data. Such devices may also include image editing applications to process the data. These applications provide tools to crop and/or rotate image content and also to alter image content, for example, by altering image brightness, color content, sharpness, and the like.

Some image editing applications alter image characteristics autonomously, thereby relieving human operators from the burden of selecting and applying image editing tools. One such automated operation involves filtering out a person. An image editing application identifies which portions of an image contain a person, e.g., based on assessments of the image. For example, in video conferencing image processing, a person may be filtered out from a captured image, and a modified version of the captured image may be transmitted to a video conferencing participant that comprises the filtered person composited onto an artificial or synthesized background image.

### SUMMARY

In general, embodiments disclosed herein relate to applying different visual effects to foreground and background portions of an image when a subject (e.g., a person, object, or group thereof) in the image is identified. Embodiments establish a smooth transition of the transparency of such subjects based on the depth of the subject in the image. This is achieved using video image segmentation techniques (e.g., machine learning (ML)-based video image segmentation techniques), as described further herein.

In one aspect, embodiments related to a non-transitory program storage device are disclosed. The program storage device is readable by one or more processors. Instructions are stored on the program storage device for causing the one or more processors to obtain a first image of a scene, the first image including at least a first subject. The processors generate a first alpha mask for the first image. The first alpha mask is generated based on an image segmentation operation, and the image segmentation operation identifies a location of the first subject within the first image. The processors generate a depth map for the first image, determine a foreground depth for the scene, and generate a second alpha mask for the first image. The second alpha mask is generated by modifying the first alpha mask based, at least in part, on comparisons between values in corresponding portions of the depth map and the determined foreground depth. The second alpha mask is applied to the first image to create a final image. The second alpha mask modifies an opacity of at least some portions of the first image corresponding to the location of the first subject, and the final image is then displayed.

In some embodiments, the alpha mask is generated based on the depth by establishing a first zone at a first given range of depths in which the transparency level of the first subject is not further modified (i.e., not transparent) based on the estimated depth of the first subject in the scene. A second zone is established at a second given range of depths in which the first subject is transparent based on the depth of the first subject in the scene, and a transition zone between the first given range of depths and the second given range of depths is established in which the first subject is partially transparent. The range of depths may be established by the system and/or a user.

In another aspect, embodiments relate to a device that includes a camera and one or more processors operatively coupled to memory. The one or more processors are configured to execute instructions causing the device to obtain a first image of a scene that includes at least two subjects, a first subject and a second subject. The device obtains a first alpha mask for the first image identifying the at least two subjects, and a depth of the second subject relative to the first subject. The device generates a second alpha mask for the first image based on the depth, and the processors apply the masks to the first image to create a final image.

In another aspect, embodiments relate to a method that includes identifying a second subject in an image and determining a relative depth of the second subject to a first subject in the image. The method further includes modifying the opacity of the second subject based on the relative depth, where the second subject is partially opaque across a range of depths. The method may further include generating an alpha mask that include a plurality of segmentation values, where each segmentation value corresponds to a pixel in the image. The method may further generate an alpha mask by establishing a first zone at a first given range of depths from the first subject in which the second subject is opaque, and a second zone at a second given range of depths in which the second subject is transparent. The second subject being partially opaque across the range of depths between the first given range of depths and the second given range of depths.

Various electronic devices are disclosed herein, in accordance with the program storage device embodiments disclosed. Such electronic devices may generally comprise a memory, one or more image capture devices (i.e., cameras), a display, a user interface, and one or more processors operatively coupled to the memory. Instructions may be stored in the memory, the instructions causing the one or more processors to perform methods in accordance with the embodiments enumerated herein.

### BRIEF DESCRIPTION OF THE DRAWINGS

FIG. 1A illustrates three images of a captured scene, each having two human subjects at different relative depths.

FIG. 1B illustrates alpha masks corresponding to the images in FIG. 1A that were produced using person segmentation operations.

FIG. 1C illustrates three images of a captured scene, each having two human subjects, wherein the opacity of one of the human subjects is determined, at least in part, based on the relative depths of the two human subjects in the captured scene, according to one or more embodiments.

FIG. 1D illustrates alpha masks corresponding to the images in FIG. 1C that were produced based on the output of person segmentation operations as modified by the relative depths of the two human subjects in the captured scene, according to one or more embodiments.

FIG. 2 is an exemplary method for performing seamless transitions in the time domain during video person segmentation, according to one or more embodiments.

FIG. 3 demonstrates a graphical representation of a degree to which determined pixel segmentation alpha values may be modified as a function of the pixel's depth in an image, according to one or more embodiments.

FIG. 4 is a block diagram illustrating an exemplary electronic device, in which one or more of the techniques disclosed herein may be implemented.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and the language may not have been selected to delineate or circumscribe the inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Embodiments disclosed herein apply different visual effects to foreground and background portions of an image when an object (e.g., a person) of interest located in the image is segmented from the remainder of the image. This may be achieved using segmentation network-based techniques, as described herein. Segmentation network techniques may be used for multiple applications, such as removing or replacing a background to make it look like an object or person in the foreground is in a different location (e.g., on the beach, in front of famous landmarks, etc.). Segmentation network techniques may also be used to place virtual objects behind a foreground person(s), in such a way that the virtual object appears to be part of the scene. For example, adding a slide presentation behind the person, but in front of other objects in the background of a scene.

In certain applications, it may be desirable to only show the object/persons(s) that are located in the foreground of the captured scene. Accordingly, when other people are in the scene behind the foreground person(s), the other people should be excluded from the processed image (e.g., by having pixels corresponding to such other people being set to be fully transparent). However, problems may occur in identifying the appropriate person(s) to display with full opacity in the processed image. Other problems may occur when a person from the background (who is currently being excluded from the final image) moves into the foreground of the scene. At some point in time, the person from the background will transition from being excluded to suddenly being included in the processed image. If only person segmentation is used, this transition will typically be sudden, and the moving person often flickers over time, e.g., as they alternate between being identifiable as a person and not being identifiable as a person by a segmentation operation.

Embodiments disclosed herein provide a solution by which persons (or other objects of interest in a scene) are provided with a smooth, gradual transition from being a part of the scene background (e.g., being fully transparent) to being a part of the scene foreground (e.g., being fully opaque). Embodiments utilize a per-pixel depth signal in order to, for example, fade in a person as he/she approaches the foreground region of the scene. Embodiments provide a gradual transition in opacity of a person or object as they move from the background to the foreground, and vice versa, e.g., based on how far behind the depth of the foreground region of the scene the person or object is currently located. The depth of the foreground region of the scene may be set relative to a current depth of a main subject in the scene, set to a predetermined depth value, or may be a customizable depth value.

Embodiments disclosed herein utilize segmentation, for example, to create a pixel-wise division of the captured scene into classes, such as between “person pixels” and “non-person pixels,” to help drive the determination of how and where masking effects should be applied to render the desired final image.

The segmentation operation, according to some embodiments, may involve a process of creating a mask, e.g., a per-pixel mask, over a captured image, wherein pixels are assigned (or “segmented”) into a predefined set of classes. Such segmentations may be binary (e.g., a given pixel may be classified as either a ‘person pixel’ or a ‘non-person pixel’), or segmentations may also be multi-class segmentations (e.g., a given pixel may be labelled as: ‘person1,’ ‘dog,’ ‘cat,’ or ‘other’).

Alpha masks may be used to encode a mapping of image pixels into two or more semantic classes, where the classes describe the semantic object or category to which the respective pixel belongs.

Depending on the specific segmentation scheme used, pixel classifications may be discrete (i.e., to encode given classes) or continuous (i.e., to encode the probability of a class). For example, with a person segmentation, rather than the output being binary (e.g., wherein a value of ‘1’=person pixel, and a value of ‘0’=non-person pixel), the network may produce intermediate probability values (e.g., 0.75=75% chance the pixel is part of a person). In addition to the alpha mask itself, depending on the segmentation scheme used, a confidence map (not shown) may also be generated. Such confidence maps encode the relative certainty of class predictions described by the alpha mask. By leveraging confidence maps and/or continuous probabilities of semantic segmentations, algorithms may be used to enhance the segmentation in a significantly more robust manner.

In embodiments disclosed herein, depth information may also be obtained as part of a segmentation process. In some embodiments, depth assignments may be made from analysis of image content itself. For example, depth estimation may be performed based on relative movement of image content across a temporally contiguous sequence of images. For example, content in a foreground of an image tends to exhibit larger overall motion in image content than background content of the same image, whether due to movement of the object itself during image capture or due to movement of a camera that performs the image capture. Depth estimation also may be performed from an assessment of an amount of blur in image content. For example, image content in focus may be identified as located at a depth corresponding to the focus range of the camera that performs image capture whereas image content that is out of focus may be identified as being located at other depths. The depth information may be used as received or used to determine the depths and/or relative depths in accordance with some embodiments herein.

In some embodiments, a camera device may utilize one (or more) cameras and image sensors to capture an input image of a scene, as well as corresponding depth/disparity information for the captured scene, which may provide an initial estimate of the depth of the various objects in the captured scene and, by extension, an indication of the portions of the captured image that are believed to be in the scene's background and/or foreground. For example, in some embodiments, the initial depth information for the captured scene may be obtained by using a secondary stereo camera, focus pixels, and/or other types of depth/disparity sensors.

In another embodiment involving a stereoscopic camera, depth assignments may be made based on a disparity map generated from images output by the stereoscopic camera. For example, image content of a right-eye image may be compared to content of a left-eye image and disparities may be calculated for each pixel location in the respective images. The disparities may represent a map from which depth values are estimated.

In some embodiments, depth assignments may be made from data sources outside the image's content. For example, when using a camera having a movable lens system, depth assignments may be derived from lens positions that are applied during auto-focus operations, which tends to correspond to a depth of foreground images from the camera. Depth assignments may be derived from a depth camera, such as a structure light or time-of-flight camera.

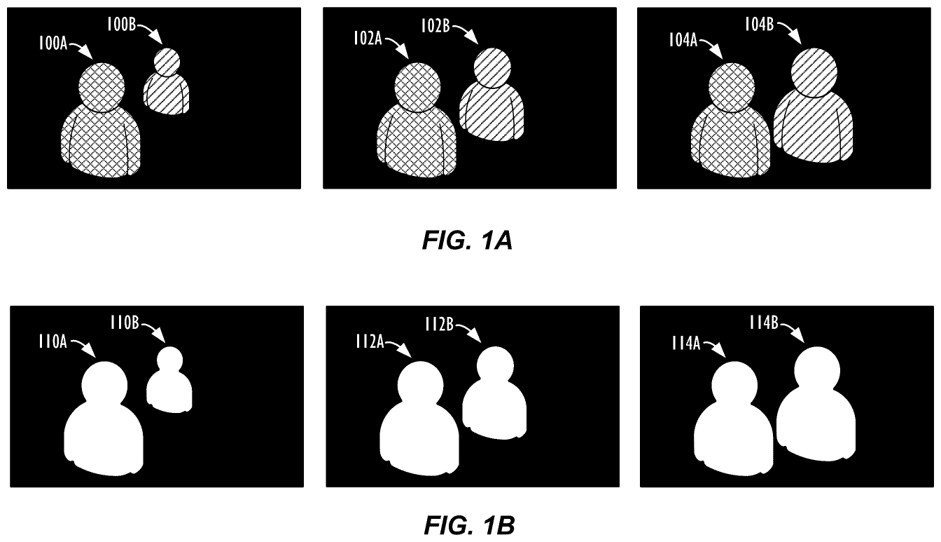

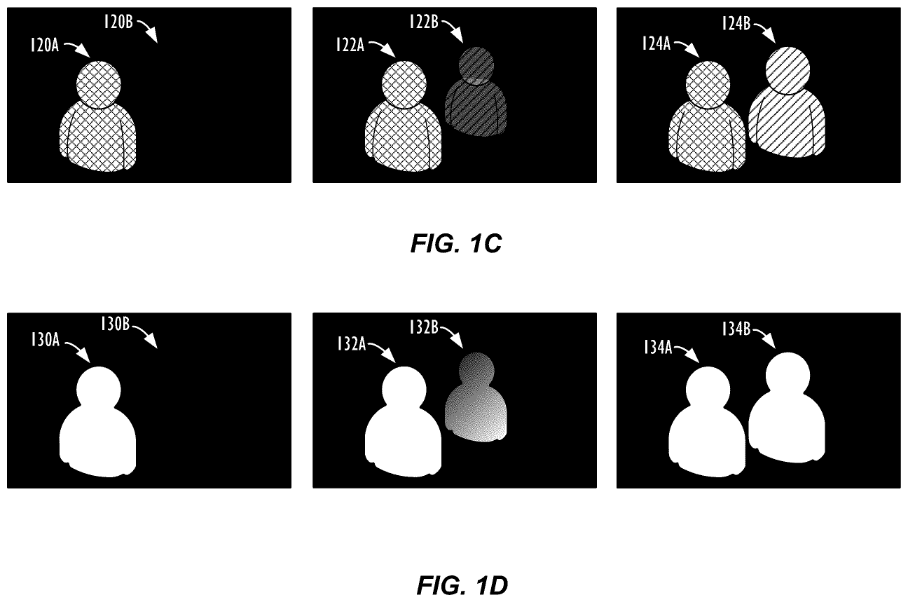

FIG. 1A illustrates three images of a captured scene, each having two human subjects at different relative depths. In the first panel of FIG. 1A, a first human subject 100A is located closer to the camera, with a second human subject 100B in a far background position. In the second panel, the second human subject 102B is located closer to the first human subject 102A, in an area referred to as a transition zone from the background to the foreground (and vice versa). In the third panel of FIG. 1A, the second human subject 104B is positioned in the foreground with the first human subject 104A.

In accordance with some embodiments, the second human subject 100B in the left frame is in the background, and thus it may be desirable to exclude the second human subject 100B from the scene, e.g., by making the pixels corresponding to the second human subject 100B fully transparent. In the middle frame, the second human subject 102B is inside a transition zone where it may be desirable to partially exclude the second human subject 102B as being in a state between full inclusion and full exclusion, e.g., by making the pixels corresponding to the second human subject 102B partially transparent. In the right image, the second human subject 104B is in the foreground, and it may be desirably to include second human subject 104B in the scene, e.g., by leaving the pixels corresponding to the second human subject 104B completely opaque.

FIG. 1B illustrates alpha masks corresponding to the images in FIG. 1A that were produced using person segmentation operations. The alpha masks shown in FIG. 1B may reflect the output of a segmentation operation, e.g., a neural network that is trained to segment out people from image frames. Such alpha masks may use a convention wherein white pixels represent the regions that comprise people pixels, and black pixels represent the regions within image determined to comprise non-people pixels. FIG. 1B illustrates the corresponding alpha masks that may be used to identify the location of persons within captured images, in accordance with some embodiments disclosed herein.

As shown, in each of the panels of FIG. 1B, the first human subject 110A, 112A, and 114A are marked as people pixels. In these panels, the second human subjects in the background 110B, 112B, and 114B are also identified as people pixels. Therefore, if the alpha masks illustrated in FIG. 1B alone are used to modify the opacity of captured image data, then the background person 100B, 102B, and 104B will always be fully opaque (i.e., not transparent, but fully visible) in the final rendered images, even when the background person is quite far from the relevant foreground depth of the image, which, in this example, may be the depth of the first human subject 110A, 112A, and 114A.

Accordingly, as will now be shown in FIGS. 1C and 1D, a preferable approach is to have the background person seamlessly and gradually transition from fully transparent to fully opaque as the background person approaches the relevant foreground depth of the image (e.g., which may be based on the current depth of the first human subject 110A, 112A, and 114A).

FIG. 1C illustrates three images of a captured scene, each having two human subjects, wherein the opacity of one of the human subjects is determined, at least in part, based on the relative depths of the two human subjects in the captured scene, according to one or more embodiments. In the first panel, the second human subject 120B in the background is correctly excluded from the image because, despite being identified as a person, the depth of the second human subject 120B is relatively far away from the relevant foreground depth of the image (i.e., the current depth of the first human subject 120A, in this example). In the middle panel, the second human subject 122B is in the transition zone (i.e., the depth of the second human subject 122B is moderately far away from the current depth of the first human subject 122A). Because the second human subject 122B is in the transition zone, the second human subject 122B is made semi-transparent. The right panel is identical to that of FIG. 1A, because the second human subject 124B is now fully in the foreground and, as such, should preferably be shown will full opacity (i.e., the depth of the second human subject 124B is close to the current depth of the first human subject 124A).

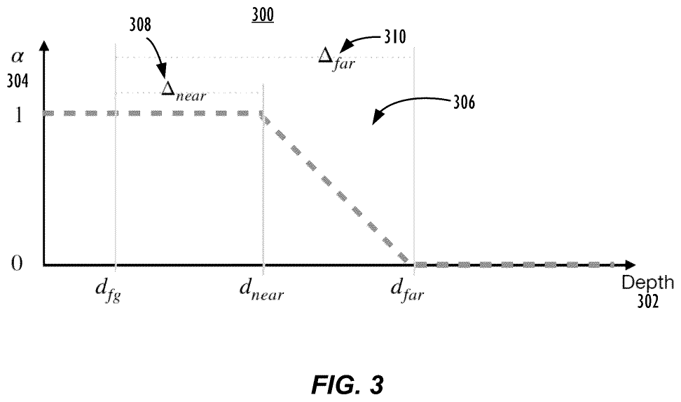

FIG. 1D illustrates alpha masks corresponding to the images in FIG. 1C that were produced based on the output of person segmentation operations as modified by the relative depths of the two human subjects in the captured scene, according to one or more embodiments. FIG. 1D illustrates a corresponding mask associated with the panels in the same column of FIG. 1C, in accordance with embodiments herein. In this example, the corresponding mask (e.g., as initially determined by a person segmentation operation) has been modified based on a relative difference between the estimated depths of the first human subject and the second human subject. As will be explained in further detail with reference to FIG. 3, various functions may be used to define how much (if at all) the values produced by an initial segmentation operation should be modified based on the estimated depth values of the corresponding portions of the captured image. The first panel of FIG. 1D illustrates the absence of the second human subject 130B (i.e., despite the pixels corresponding to second human subject 130B being correctly identified by a segmentation operation as belonging to a person, the values of such pixels in the alpha mask have been set to zero, based on the estimated depth of second human subject 130B being relatively far away from the depth of first human subject 130A), while the third panel illustrates the complete presence of the second human subject 134B (i.e., the pixels corresponding to second human subject 134B have been correctly identified by the segmentation operation as belonging to a person, and the values of such pixels in the alpha mask have not been further modified, based on the estimated depth of second human subject 134B being relatively close to the depth of first human subject 134A). The second panel illustrates a modified partial transparency of the second human subject 132B as a result of being within a specified range of a foreground depth in the image (i.e., the pixels corresponding to second human subject 132B have been correctly identified by the segmentation operation as belonging to a person, but the values of such pixels in the alpha mask have been modified to some extent, e.g., made somewhat more transparent, based on the estimated depth of second human subject 132B being moderately far away the depth of first human subject 132A). In some embodiments, the specified range within the scene wherein the values of pixels in the alpha mask may be modified to some extent may be established relative to the current depth of the first human subject 132A.

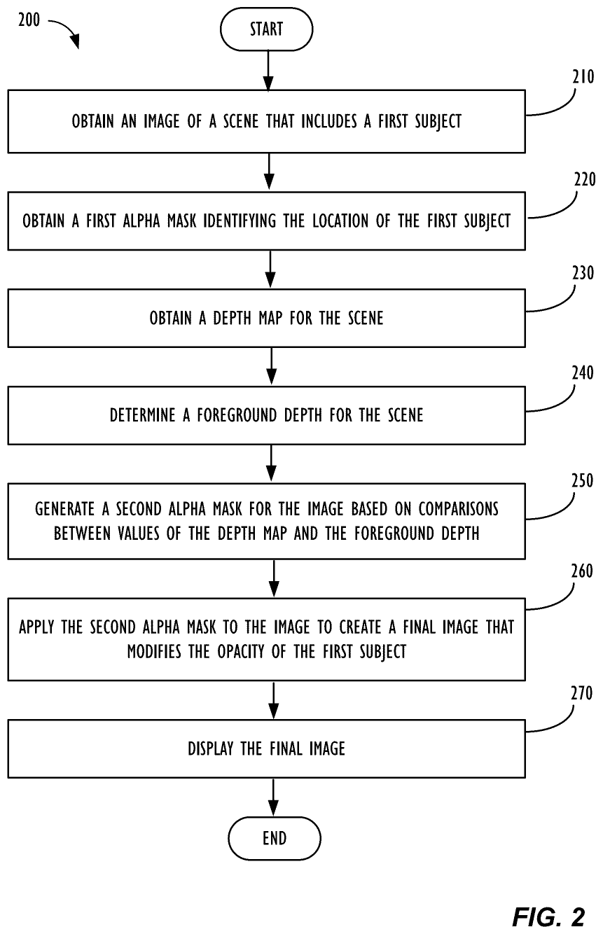

Turning now to FIG. 2, an exemplary method for performing seamless transitions in the time domain during video person segmentation is described, according to one or more embodiments described herein. First, the method 200 may begin by obtaining an image of a scene that includes a first subject in Step 210. The scene may include multiple subjects, such as people. In this context, the first subject refers to a subject that seamlessly transitions between the foreground and background. One of ordinary skill in the art will appreciate that embodiments herein are not limited to just people, but may also apply to objects, groups of objects and/or people, and Regions of Interest (ROI) that may be detected/segmented within the image.

Next, in Step 220, the process obtains a first alpha mask identifying the first subject. Optionally, a corresponding confidence mask for the first alpha mask may also be obtained (and/or the first alpha mask may itself comprise a confidence mask). As previously discussed, the segmentations may be binary, multi-class, or even continuous. The segmentation masks and confidence masks may be produced by a neural network or other machine learning-based system. A confidence mask may reflect the confidence that the given neural network or other machine learning-based system has in the segment classification of any given pixel in the reference color image. In embodiments disclosed herein, an alpha mask may include a plurality of segmentation values, where each segmentation value corresponds to a pixel in an image.

Next, the method 200 obtains a depth map for the scene in Step 230. Depth assignments may also be made in addition to the segmentation process from an analysis of the image content, and/or by using other information obtained through the camera device. For example, the depth map may be generated using a monocular depth neural network, stereo camera depth information, a time of flight camera, structured light sensors, phase detection pixels, etc.

The method 200 then determines a foreground depth for the scene in Step 240. The foreground depth may be determined based on an estimated depth of the first subject, an estimated depth of another (second) subject identified by the image segmentation operation, a predetermined foreground depth value, or a focus setting of the camera. The foreground depth may also be set, or adjusted, by a user.

Next, at Step 250, the method 200 generates a second alpha mask for the image by modifying the values in the first alpha mask based on comparisons between the estimated depth values of the pixels in the depth map and the determined foreground depth value from Step 240. The depth of the first subject may be relative to another subject in the image, or based on some other reference point (e.g., camera position).

The values in the second alpha mask may represent an amount of transparency (or opacity) of the subject in the final image. For example, a value of “1” may be established to represent no transparency (i.e., completely visible/opaque); and a value of “0” may be established to represent complete transparency (i.e., completely invisible). Values between 0 and 1 may represent an amount of transparency based on a percentage, such as an alpha value of 0.5 representing a pixel having 50% transparency in the final image. One example of a functional relationship between an amount of transparency modification to be applied to a pixel and a depth of a pixel relative to a defined foreground depth is given below in FIG. 3.

The second alpha mask, as well as any other obtained alpha masks, are applied to the image to obtain a final image in Step 260. For example, if Iᵢₙ is an RGB input image, and α_{seg} may be a mask generated by a segmentation network, and I_{seg}=Iᵢₙ·α_{seg}, wherein the alpha mask, α_{seg}, in the equation above corresponds to the “first alpha mask” in FIG. 2, demonstrated in the example of FIG. 1B. If α_{depth} represents another alpha mask of values specifying how much (if at all) to modify the values in the α_{seg} mask based on the relative difference in the depth of each pixel in the image as compared to the determined foreground depth value for the scene (as will be explained in further detail with reference to FIG. 3), then the final image may be represented as: I_{final}=Iᵢₙ·α_{final}=Iᵢₙ·α_{seg}·α_{depth}, wherein the alpha mask, α_{final}, in the equation above corresponds to the “second alpha mask” in FIG. 2, which is ultimately applied to the input image to generate the final image, and which may be computed by multiplying the values in α_{seg} with the corresponding values in α_{depth}. In Step 270, the final image is displayed. One of ordinary skill in the art will appreciate that the final image may undergo additional processes prior to being displayed.

FIG. 3 demonstrates a graphical representation of a degree to which determined pixel segmentation alpha values may be modified as a function of the pixel's depth in an image, according to one or more embodiments. In FIG. 3, the x-axis 302 represents the depth of a given pixel, while the y-axis 304 represents an alpha value modifier based on depth, or α_{depth}. A position of a foreground depth is given by d_{fg}, and a transition zone 306 is defined between defined values for dₙₑₐᵣ and d_{far}. In other words, a distance from the camera anywhere in the range between dₙₑₐᵣ to d_{far} may determine the “transition zone,” wherein the opacity of a segmented subject (e.g., a person) in the image is at least somewhat modified. FIG. 3 also shows a range of depths Δₙₑₐᵣ 308, which defines a zone in which a segmented subject may remain fully opaque, i.e., has an alpha value of 1, and a range of depths Δ_{far} 310, which defines a zone in which the alpha value of a pixel may begin to be modified (i.e., decreased opacity) and beyond which a second subject is fully transparent, i.e., has an alpha value of 0, i.e., when the depth of a pixel is greater than d_{far}. In other words, the segmentation value of a pixel in Δₙₑₐᵣ is fully determined by the corresponding pixel's segmentation value in the original alpha mask, and the segmentation value of a pixel beyond d_{far} is 0, regardless of the segmentation value in the original alpha mask. This has the beneficial effect of making objects at specified depth ranges in the scene—even those that are a part of the desired segmented class (e.g., a person)—not appear in the final processed image.

The functional relationship demonstrated in the example graph of FIG. 3 may be written as:

$${α}_{depth} = \{ \begin{matrix}1 & for d < {d}_{near} \\ 1 - \frac{d - {d}_{near}}{{d}_{far} - {d}_{near}} & for {d}_{near} \leq d \leq {d}_{far} \\ 0 & for d > {d}_{far}\end{matrix}$$

In the above equation, the α_{depth} value is 1 for a subject closer than dₙₑₐᵣ (e.g., including subjects located at d_{fg}). The opacity has a linear falloff between dₙₑₐᵣ and d_{far} based on the relative depth of the pixel with respect to dₙₑₐᵣ and d_{far}, and the opacity is 0 for pixels at depths greater than d_{far}—regardless of the respective pixels' value in alpha masks produced by any other segmentation operations.

The above equation is one example of a relationship for the opacity of a subject as a function of depth in the transition zone. One of ordinary skill in the art will appreciate that embodiments are not limited to the linear expression for the transition zone given above. Embodiments may take many functional forms in the transition zone provided the function is continuous at dₙₑₐᵣ and d_{far}. For example, a quadratic or exponential functional relationship may be used.

In embodiments disclosed herein, the parameters that define the seamless transition may be predetermined, established automatically based on conditions associated with the scene, set by a user, or combinations thereof. More specifically, Δₙₑₐᵣ establishes an area behind a subject in which other subjects may be visible. The value of Δₙₑₐᵣ may be predetermined, for example 0.5 m, to establish an area in which a second subject is visible. In some embodiments, the value of Δₙₑₐᵣ may be based on observations/conditions in the scene, such as number of detected subjects, natural barriers in the scene, noise levels, etc. In some embodiments, the value of Δₙₑₐᵣ may be set by a user, or the first subject, based on a privacy preference or current conditions.

In one exemplary embodiment, the Δₙₑₐᵣ may be initially established, either by being predetermined or based on the scene, and the user may be able to subsequently adjust Δₙₑₐᵣ to a preference. Such adjustments may occur while processing, for example during a video conference.

Similar considerations may be taken regarding the establishment of Δ_{far} in accordance with embodiments herein. That is, Δ_{far} may be predetermined, established automatically based on conditions associated with the scene, set by a user, or combinations thereof.

In the example of FIG. 3, the distances are presented relative to the camera position; however, embodiments should not be limited as such. The distances and formulation may be established relative to the foreground depth d_{fg}. The foreground depth d_{fg} may be set at a depth of particular interest in the captured scene, such as the depth of another (i.e., second) subject in the scene.

In other implementations, the foreground depth d_{fg} may alternatively be determined based on the estimated depth of one or more subjects identified by the image segmentation operation, a predetermined value, a setting of the camera (e.g., focus), or by a user-controllable value.

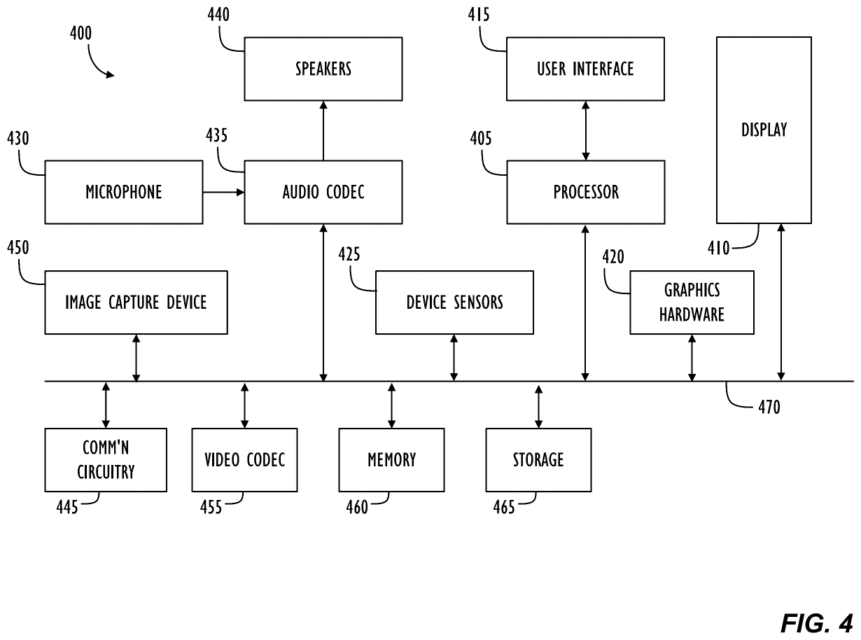

FIG. 4 demonstrates a simplified functional block diagram of illustrative programmable electronic device 400 according to one or more embodiments disclosed herein. The electronic device 400 could be, for example, a mobile telephone, personal media device, portable camera, or a tablet, notebook, or desktop computer system. As shown, electronic device 400 may include processor 405, display 410, user interface 415, graphics hardware 420, device sensors 425 (e.g., proximity sensor/ambient light sensor, accelerometer and/or gyroscope), microphone 430, audio codec(s) 435, speaker(s) 440, communications circuitry 445, image capture device 450, which may, e.g., comprise multiple camera units/optical image sensors having different characteristics or abilities (e.g., High Dynamic Range (HDR), Optical Image Stabilization (OIS) systems, optical zoom, digital zoom, etc.), video codec(s) 455, memory 460, storage 465, and communications bus 470.

Processor 405 may execute instructions necessary to carry out or control the operation of many functions performed by electronic device 400 (e.g., such as the generation and/or processing of alpha masks in accordance with the various embodiments described herein). Processor 405 may, for instance, drive display 410 and receive user input from user interface 415. User interface 415 can take a variety of forms, such as a button, keypad, dial, a click wheel, keyboard, display screen and/or a touch screen. User interface 415 could, for example, be the conduit through which a user may view a captured video stream and/or indicate particular frame(s) that the user would like to capture (e.g., by clicking on a physical or virtual button at the moment the desired frame is being displayed on the device's display screen). In one embodiment, display 410 may display a video stream as it is captured while processor 405 and/or graphics hardware 420 and/or image capture circuitry contemporaneously generate and store the video stream in memory 460 and/or storage 465. Processor 405 may be a system-on-chip such as those found in mobile devices and include one or more dedicated graphics processing units (GPUs). Processor 405 may be based on reduced instruction-set computer (RISC) or complex instruction-set computer (CISC) architectures or any other suitable architecture and may include one or more processing cores. Graphics hardware 420 may be special purpose computational hardware for processing graphics and/or assisting processor 405 perform computational tasks. In one embodiment, graphics hardware 420 may include one or more programmable graphics processing units (GPUs).

Image capture device 450 may comprise one or more camera units configured to capture images, e.g., images which may be processed to generate seamless opacity transitions for subjects of interest in the captured images, e.g., based on their depths in the captured scene, in accordance with this disclosure. Output from image capture device 450 may be processed, at least in part, by video codec(s) 455 and/or processor 405 and/or graphics hardware 420, and/or a dedicated image processing unit or image signal processor incorporated within image capture device 450. Images so captured may be stored in memory 460 and/or storage 465. Memory 460 may include one or more different types of media used by processor 405, graphics hardware 420, and image capture device 450 to perform device functions. For example, memory 460 may include memory cache, read-only memory (ROM), and/or random access memory (RAM). Storage 465 may store media (e.g., audio, image, and video files), computer program instructions or software, preference information, device profile information, and any other suitable data. Storage 465 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 460 and storage 465 may be used to retain computer program instructions or code organized into one or more modules and written in any desired computer programming language. When executed by, for example, processor 405, such computer program code may implement one or more of the methods or processes described herein.

It is to be understood that the above description is intended to be illustrative, and not restrictive. Embodiments have the advantage of seamlessly transitioning one or more subjects into a scene when video conferencing. Embodiments allow a system or user to establish zones in which additional subjects may be visible, partially visible, or invisible when video conferencing. Such transitions may be easily incorporated into other existing segmentation image processes in accordance with embodiments disclosed herein.

Many other embodiments will be apparent to those of skill in the art upon reviewing the above description. The scope of the invention therefore should be determined with reference to the appended claims, along with the full scope of equivalents to which such claims are entitled.

What is claimed is:

1. A non-transitory computer readable storage medium storing program instructions that, when executed by a processing device, cause the device to:
obtain a first image of a scene, the first image comprising at least a first subject;
generate a first alpha mask for the first image, wherein the first alpha mask is generated based on an image segmentation operation, and wherein the image segmentation operation identifies a location of the first subject within the first image;
generate a depth map for the first image;
determine a foreground depth for the scene;
generate a second alpha mask for the first image, wherein the second alpha mask is generated by modifying the first alpha mask based, at least in part, on comparisons between values in corresponding portions of the depth map and the determined foreground depth;
apply the second alpha mask to the first image to create a final image, wherein applying the second alpha mask modifies an opacity of at least some portions of the first image corresponding to the location of the first subject; and
display the final image.

2. The non-transitory computer readable storage medium of claim 1, wherein the first alpha mask comprises a plurality of segmentation values, wherein each segmentation value corresponds to a pixel in the first image.

3. The non-transitory program storage device of claim 1, wherein the first alpha mask is obtained as an output from a neural network.

4. The non-transitory program storage device of claim 1, wherein the image segmentation operation identifies persons or other objects of interest in an image.

5. The non-transitory program storage device of claim 1, wherein the second alpha mask modifies a transparency level of portions of the first image.

6. The non-transitory computer readable storage medium of claim 1, wherein generating the second alpha mask comprises:
establishing a first zone at a first range of depths in the scene in which the first subject is not transparent;
establishing a second zone at a second range of depths in the scene in which the first subject is transparent; and
establishing a transition zone between the first range of depths and the second range of depths in which the first subject is partially transparent.

7. The non-transitory computer readable storage medium of claim 6, wherein generating the second alpha mask values for pixels with depth values in the first zone comprises:
multiplying each corresponding first alpha mask value with a value of 1.

8. The non-transitory computer readable storage medium of claim 6, wherein generating the second alpha mask values for pixels with depth values in the second zone comprises:
multiplying each corresponding first alpha mask value with a value of 0.

9. The non-transitory computer readable storage medium of claim 6, wherein generating the second alpha mask values for pixels with depth values in the transition zone comprises:
multiplying each corresponding first alpha mask value with a value between zero and one.

10. The non-transitory computer readable storage medium of claim 9, wherein the value between zero and one is determined based, at least in part, on the foreground depth.

11. The non-transitory computer readable storage medium of claim 6, wherein the transparency of the portions of the image in the transition zone increases linearly with the depth of the respective portions of the image.

12. The non-transitory computer readable storage medium of claim 6, wherein the first range of depths is set by a user.

13. The non-transitory computer readable storage medium of claim 6, wherein a range of the transition zone is set by a user.

14. The non-transitory computer readable storage medium of claim 1, wherein the foreground depth is determined based on one of the following: an estimated depth of the first subject; an estimated depth of a second subject identified by the image segmentation operation; a predetermined value; a focus setting of the camera; or a user-controllable value.

15. The non-transitory computer readable storage medium of claim 1, wherein the depth map is generated using one of the following: a monocular depth neural network, stereo camera depth information, a time of flight camera, structured light sensors, or phase detection pixels.

16. A device, comprising:
a camera; and
one or more processors operatively coupled to memory, wherein the one or more processors are configured to execute instructions causing the one or more processors to:
obtain a first image of a scene, the first image comprising at least two subjects, a first subject and a second subject;
obtain a first alpha mask for the first image identifying the at least two subjects;
determine a depth of the second subject relative to the first subject;
generate a second alpha mask for the first image based on the depth; and
apply the first alpha mask and the second alpha mask to the first image to create a final image.

17. The device of claim 16, wherein generating the second alpha mask based on the depth comprises:
establishing a first zone at a first range of depths from the first subject, in which the second subject is not transparent in the final image;
establishing a second zone at a second range of depths, in which the second subject is transparent in the final image; and
establishing a transition zone between the first range of depths and the second range of depths, in which the second subject is partially transparent in the final image.

18. The device of claim 17, wherein a range of the transition zone is set by a user.

19. An image processing method, comprising:
identifying a second subject in an image;
determining a depth of the second subject relative to a first subject in the image; and
modifying the opacity of the second subject based on its depth relative to the first subject, wherein the modification causes the second subject to become partially opaque across a range of relative depths.

20. The method of claim 19, wherein modifying the opacity of the second subject based on its depth relative to the first subject further comprises:
establishing a first zone comprising a first range of depths relative to the first subject, in which the opacity of the second subject is fully opaque; and
establishing a second zone comprising a second range of depths relative to the first subject, in which the opacity of the second subject is modified to be fully transparent,
wherein the opacity of the second subject is modified to be partially opaque across a transition zone comprising a range of depths between the first range of depths and the second range of depths.
